(19) United States
(12) Patent Application Publication
(10) Pub. No.: US 2007/0016612 A1
(43) Pub. Date: Jan. 18, 2007

(54) MOLECULAR KEYWORD INDEXING FOR CHEMICAL STRUCTURE DATABASE STORAGE, SEARCHING, AND RETRIEVAL

(75) Inventors: Craig A. James, Escondido, CA (US); Klaus Gubernator, Del Mar, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: eMolecules, Inc., Del Mar, CA (US)

(21) Appl. No.: 11/456,851

(22) Filed: Jul. 11, 2006

Related U.S. Application Data
(60) Provisional application No. 60/698,511, filed on Jul. 11, 2005.

(51) Int. Cl. G06F 7/00

(52) U.S. Cl. 707/104.1

(57) ABSTRACT

Data that represents chemical structures, and fragments thereof, are transformed into corresponding molecular keywords comprising letters and numbers that are associated with the original data representation. These molecular keywords encode the structural features of a given chemical structure. Molecular keywords are generated for linear structures, branching points, adjacent branching points, monocyclic, polycyclic and macrocyclic ring systems, stereo centers, ring-substituent patterns and molecular-formula atom counts. Indexing, database searching, and Web page presentation can be provided in conjunction with the molecular keywords representation.

### CROSS-REFERENCE TO RELATED APPLICATIONS

This application claims the benefit of priority of co-pending U.S. Provisional Application Ser. No. 60/698,511 filed Jul. 11, 2005 entitled “Molecular Keyword Indexing Technology for Chemical Structure Database Storage, Searching and Retrieval” by Craig A. James and Klaus Gubernator. Priority of the filing date of Jul. 11, 2005 is hereby claimed, and the disclosure of the Provisional application is hereby incorporated by reference.

### BACKGROUND

1. Field of the Invention

The present invention relates to database management systems that store, search and retrieve chemical structure information very efficiently.

2. Description of the Related Art

Chemical and pharmaceutical industries and chemistry oriented academic and government agencies commonly maintain very large databases of chemical structures which also have associated structure searching capabilities. In a recent development some of these databases have become publicly available through world wide web access.

For a given chemical or pharmaceutical research project it is important to have access to information related to specific chemical structures relevant to such projects, and to be able to identify chemical structures which are in some defined way related to one another. Such relevant information may be in the public domain or reside in a proprietary database. In general the size and complexity as well as the public availability of chemical-structure databases continues to increase (www.pubchem.com; Irwin, J. J., Shoichet, B. K., J. Chem. Inf. Model. 2005, 43, 177-182). While there are search engines associated with the current databases, most of today's chemical information systems do not have the capacity to allow efficient searches across multiple distributed databases nor can they efficiently handle millions of chemical structures. In addition, most of today's chemical information systems are not capable of rapidly providing partial answers, such as when presenting a single page of results to a chemist using a web browser.

The prevailing method for storing and searching large volumes of data is relational database technology. Queries and data management are performed using the standard structured query language, SQL. Oracle, a commercial database software from Oracle Corporation, (Redwood City, Calif.), or PostgreSQL, an open source database system which originated at the University of California, Berkeley are examples of well known relational database management systems (RDBMS). These RDBMS typically are installed on database server hardware running the Unix or Linux operating system.

Text searching of very large text document databases is an established technology. Documents are typically analyzed for keywords and word stems and these are indexed using hash, tree, B-tree or G-tree indices (Knuth, D., The Art of Computer Programming, Volume 3, 473-479 and 506-549 (Addison-Wesley 1973); Knuth D. E., Morris J. H., and Pratt V. R., Fast pattern matching in strings, SIAM Journal on Computing, 6(2), 323-350,1977). Document databases containing millions of documents (in the case of web search engines like Google.com of Yahoo.com, billions of pages) can be searched for matching words in a matter of seconds.

Nevertheless, browser-based web applications have two characteristics that are not handled well by most established document searching and indexing technology. First, web applications such as search engines typically utilize partial results, such as a “page” of ten answers that are delivered nearly instantly, followed an indeterminate time later by another page (another partial answer), and so forth. Second, web applications maintain very little “state” information, that is, each time the user goes to the next page of results, there is little or no information available from the previous partial search that the RDBMS conducted.

Web applications utilize partial search results to help speed up response time, but most established document searching and indexing technology will search through an entire database and return all the located search “hits”, possibly slowing down the response time. Likewise, maintaining little or no state information for the web application is less taxing on machine resources, but again, most conventional technologies save a variety of state information concerning data operations and thereby require greater resources and slow down response times.

There are particular challenges to creating and searching databases of chemical structures. Chemical structures are defined by both their constitution and their configuration. However, most chemical database systems are restricted to the structural topology of molecules, i.e. atoms and their connectivity through chemical bonds. Such topological two-dimensional descriptions of molecules can be encoded in connection tables or in linear text notation like SMILES (Weininger, D., J. Chem. Inf. Comput. Sci., 1988, 28, 31; www.daylight.com/smiles) or other formats. Although these have the advantage of being computer readable, they cannot readily be used for indexing. In order to compare structures or structural fragments in topology-based databases, these encodings have to be canonicalized (Morgan, H. L., J. Chem. Doc., 1965, 5, 107-113). Typically, indexing is done by either (1) deriving a fixed set of predefined keys (MDL Information Systems, Inc. 14600 Catalina Street, San Leandro, Calif. 94577; Durant, J. L., Leland, B. A., Henry, D. R., Nourse, J. G., J. Chem. Inf. Comput. Sci. 2002, 42, 1273-1280), (2) generating an exhaustive list of keys corresponding to linear pathways (www.daylight.com ; Singh, S. B., Hull, R. D., Fluder, E, M., J. Chem. Inf. Comput. Sci. 2003, 43, 743-752)) or (3) generating atom environment keys (Moore, J., Brazil, J., Hoover, J. R., U.S. Pat. No. 6,304,869).

Substructure searching consists of identifying a partial structure of a molecule that is identical to the query. This process is known to be inherently slow (Knuth, D., The Art of Computer Programming, Volume 3, 473-479, Addison-Wesley 1973), so the performance of a chemical information system is dependent on the number of structures on which such searches have to be performed. Structural queries are typically performed as a two step process where indexing, as described above, is used to retrieve only structures with a high probability of matching the query, followed by substructure searching. The more efficient the indexing step is, the fewer substructure searches need to be performed. It follows, therefore, that the most efficient indexing technology will lead to the most efficient chemical search technology.

### SUMMARY

Embodiments of the invention described herein provide a method of translating data that represents chemical structures, and fragments thereof, into corresponding molecular keywords comprising letters and numbers that are associated with the original data representation. These molecular keywords encode the structural features of a given chemical structure. The set of molecular keywords for a particular molecule are referred to herein as a “document.” In some cases, a molecule will have no structural features that generate keywords; in that case, the document will be empty, or the document will comprise a default molecular keyword character or symbol, such as *, or another character selection. In this way, a chemical molecular database can be processed to include corresponding molecular keyword documents. A chemical-structure query can be received and transformed into a set of corresponding molecular keywords, which can be used to search the chemical structure database and associated database molecular keywords with conventional database management techniques. In this way, a chemical structures database can be processed so as to include molecular keyword data in addition to the original chemical structures data, in an efficient text-based data representation that lends itself to efficient storage, search, and retrieval techniques.

In additional embodiments, a text index of the keywords can be created, referred to herein as an “index of molecular keywords,” for more efficient search processing. The text index of molecular keywords can be added to a database-of chemical structures. A chemical-structure query can be transformed into a set of corresponding molecular keywords, which are then used to rapidly search the indexed chemical database for identical structures, substructures, or similar structures. Only matches found via the text index are then subject to a substructure search.

The embodiments of the invention create a document for each molecule using the molecular keywords corresponding to the molecule, which means the system can use modern text searching tools and hence is able to efficiently search large databases of chemical structures. The molecular keywords represent structural features of the molecule. The techniques of the present invention provide an advantage over previously described methods in that the novel techniques concurrently implement a number of different keyword-generation strategies, including, but not limited to assigning keywords to: linear structures, branching points, adjacent branching points, monocyclic, polycyclic and macrocyclic ring systems, stereo centers, ring-substituent patterns and molecular-formula atom counts.

Embodiments of the invention also provide a method for efficiently indexing text documents. The techniques of the present invention further provide an advantage over previously described methods in that the novel techniques allow rapid calculation of partial results; for example, embodiments can return the first ten molecules that match a query without examining the entire database, and in a subsequent request, can return the next ten molecules, without reexamining the previously-returned molecules, and so forth.

It is an advantage of the techniques provided by the present invention that molecular keywords are generated automatically based on processing rules without prior knowledge of the content of the chemical database. The method is therefore general and applicable to any type of chemical structure database, including but not limited to pharmaceutical, agrochemical, environmental, building block, petrochemical, organometallic databases, or any combination thereof.

It is a further advantage of the techniques provided by the present invention that an exact match of a keyword guarantees an exact match of the substructure of the query to a substructure of the hit. The keywords are therefore deterministic, since the keyword itself is used for an indexing method that maintains all keywords as individual index items.

Yet another advantage of the techniques of the present invention is that a very large number of different index keywords are used for all molecules in a large database without negatively affecting performance. This is, therefore, a method that overcomes the limitations of present chemical search technologies, which all use one or a limited range of indexing strategies, and enables chemical databases of millions of structures to be searched efficiently.

Yet another advantage of the techniques of the present invention is that it is well suited to searching via web browsers on the world wide web. Chemists searching a database via a web browser expect very rapid response, and a typical web application returns partial answers, such as ten molecules per “page,” rather than a single complete page with all results. The present invention overcomes the limitations of RDBMS systems, which typically are not efficient at returning partial answers.

Yet another advantage of the techniques of the present invention is that keywords can be generated for any information that can be represented as a mathematical graph with labeled nodes and edges. For example, among other things, the present invention could be applied to maps or electrical circuit diagrams.

Other features and advantages of the present invention should be apparent from the following description of the preferred embodiment, which illustrates, by way of example, the principles of the invention.

### BRIEF DESCRIPTION OF THE DRAWINGS

FIG. 1 is a flow diagram that depicts operations performed by a search system constructed in accordance with the invention to provide chemical database storage, searching, and retrieval.

FIG. 2 is a flow diagram that depicts system operations to perform keyword generation in accordance with the invention.

FIG. 3 is a flow diagram that depicts system operations to perform generating keywords for linear structures.

FIG. 4 is a flow diagram that depicts system operations to generate keywords for branching points.

FIG. 5 is a flow diagram that depicts system operations to generate keywords for adjacent branching points.

FIG. 6 is a flow diagram that depicts system operations to generate keywords for monocyclic structures.

FIG. 7 is a flow diagram that depicts system operations to generate keywords for polycyclic structures.

FIG. 8 is a flow diagram that depicts system operations to generate keywords for stereo centers.

FIG. 9 is a flow diagram that depicts system operations to generate keywords for ring substituent patterns.

FIG. 10 is a flow diagram that depicts system operations to generate keywords for molecular formula atom counts.

FIG. 11 is a flow diagram that depicts system operations to create an index of the keywords in a document.

FIG. 12 is a flow diagram that depicts system operations to prepare data structures for a specific query.

FIG. 13 is a flow diagram that depicts system operations to provide data structures built from molecular keywords.

FIG. 14 is a flow diagram that depicts system operations to find the next candidate row that contains every keyword in the query.

FIG. 15 is a block diagram that illustrates the construction of a system that performs the operations illustrated in FIGS. 1-14.

FIG. 16 is a user interface computer display that illustrates an input operation of the system illustrated in FIG. 15.

FIG. 17 is a user interface computer display that illustrates returned search results for the structure input shown in FIG. 16.

### DETAILED DESCRIPTION

Chemical Database Storage, Searching and Retrieval

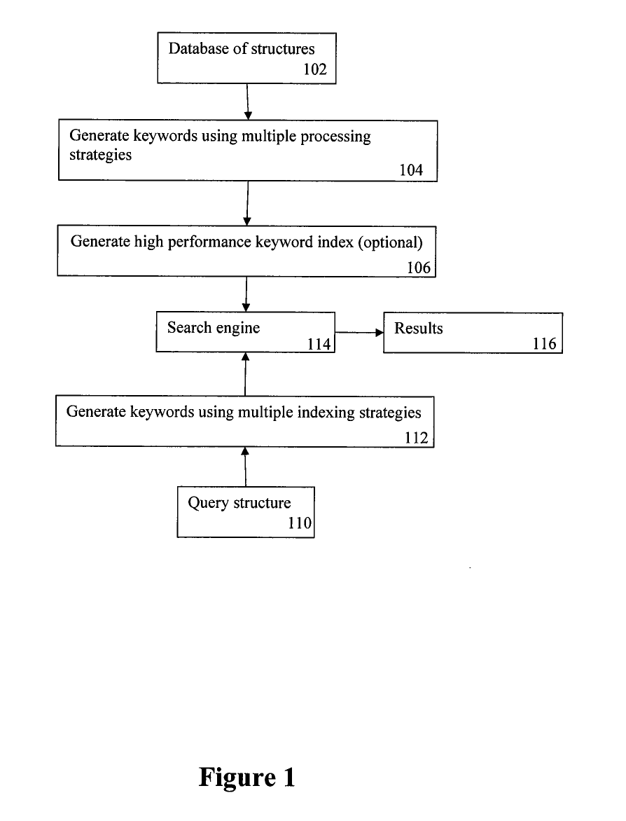

In some embodiments, the present invention implements a very efficient chemical database system by generating molecular keywords using multiple keyword generating strategies, storing them in an optional high performance keyword index, and implementing a search engine using this index (FIG. 1). Keywords derived from a query structure are used to search the database, retrieve results and present them in a web browser.

FIG. 1 shows the operations of a database system for performing chemical structure searches in accordance with the invention. Access to a database of chemical structures is provided, as represented by the flow diagram box numbered 102. The system then processes the chemical structures database and generates molecular keywords using multiple keyword generating strategies, which are described further below. The database processing is indicated by the flow diagram box numbered 104. Next, at box 106, the system optionally generates a high performance keyword index. The keyword index can improve the efficiency of database searches. Once the keyword index is available, a system user can provide a query that specifies a chemical structure, as indicated at box 110. The system then generates keywords from the query, using multiple keyword generating strategies, as before. This operation is represented by box 112. At box 114, the query keywords are provided to a search engine, which carries out query processing against the generated database keywords (and the optional keyword index, if available) and provides the results to the user in a viewing application such as a Web browser (at box 116).

Molecular Keywords

The database containing the chemical structures data representations can be configured to include graphical representations (e.g. molecular graph) or text-based representations. The system includes storage, search, and retrieval mechanisms that can interface with the data configuration of the database. Embodiments can be implemented to interface with multiple, different data configurations for the database.

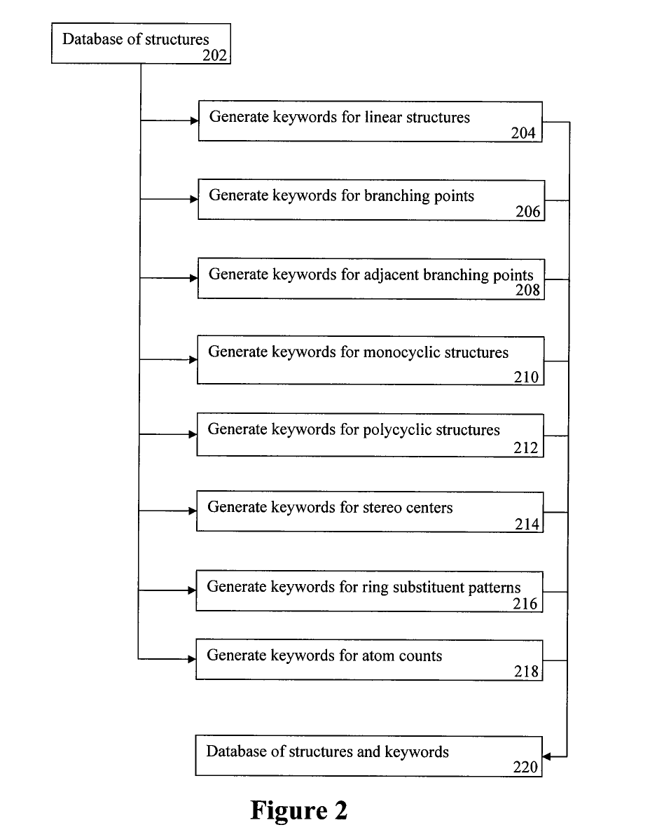

In some embodiments, the system generates molecular keywords for text representation of chemical structures, which then can be searched in conjunction with optional indexing. It analyzes molecular topological pathways dynamically and assigns text keywords to each pathway. It thereby converts a molecular graph to a document of words (the molecular keywords) which then can be indexed using a text search method. To generate the molecular keywords, the system uses a number of keyword generating strategies, including, but not limited to assigning keywords to: linear structures, branching points, adjacent branching points, monocyclic, polycyclic and macrocyclic ring systems, stereo centers, ring-substituent patterns and molecular-formula atom counts (FIG. 2). It is possible that some molecules will generate no keywords at all. In such circumstances, the system will return no keyword character or will return a predefined null character, such as a “*” character or the like.

FIG. 2 illustrates processing of the system in carrying out the multiple keyword generating strategies. The chemical structures database is accessed (box 202) and is processed to generate keywords for database structures that are identified as linear structures at box 204, branching points 206, adjacent branching points 208, monocyclic structures 210, polycyclic structures 212, stereo centers 214, ring substituent patterns 216, and atom counts 218. The resulting database of chemical structures and keywords is then available for other system processes at box 220. Those skilled in the art will appreciate that indexing strategies in addition to those illustrated above 204-218 can be utilized. Details of the illustrated keyword strategies 204-218 will be described next, wherein molecular keywords are assigned to structural elements of the chemical structure in the database through iterative processing.

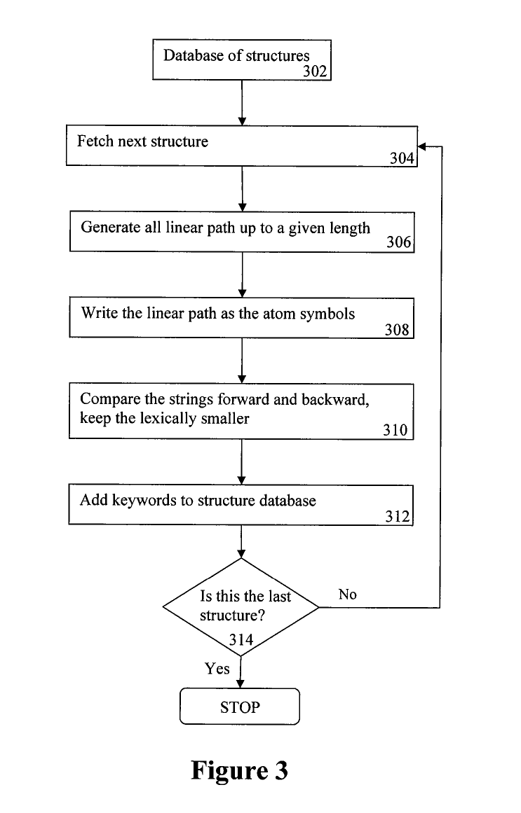

One of the iterative keyword processing strategies is for generating keywords based on linear structures, as indicated in box 204 of FIG. 2. The processing operations for generating linear structure keywords 204 are illustrated in the flow diagram of FIG. 3.

In the initial operation, indicated by the box 302 in FIG. 3, the system gains access to the database of chemical structures. Each structure within the database is accessed in turn, as indicated by the “fetch next structure” operation in the next box 304. From the database representation of each chemical being processed, the molecular structure is analyzed for symmetry, and atoms are assigned to classes, one class per group of symmetrically-equivalent atoms. Atoms are listed using one of each class. For each atom from this list, every linear, acyclic path from that atom to another atom is generated as a text string of atomic symbols, except that paths longer than a predefined length (such as five or more bonds) are not considered. Multiple bonds are denoted in the text string by numbers. Thus, all linear paths up to a selected length are generated, as represented by box 306. The generated linear paths are represented by text strings of atomic symbols (box 308). Every text string will then occur forward and backward; only the string with the lower lexical (alphabetical) order is kept as the corresponding keyword, as indicated at box 310. Finally, duplicate strings are eliminated. The resulting text strings are the molecular keywords for linear structures and are added to the database, incorporating the original molecular structures and the corresponding keywords for each structure (box 312). This processing is repeated for each structure in the database until the system has cycled through all the structures, as indicated by the return path from box 314 to box 304.

An example of the processing illustrated in FIG. 3 is the keyword set that would be generated by the linear structure processing for alanine, having a SMILES representation and corresponding linear structure keyword set as follows: Alanine: SMILES: NC(C)C(═O)O; keywords: CC, CN, CO, C2O , CCN, CCO, CC2O, NCC, NCCO, NCC2O .

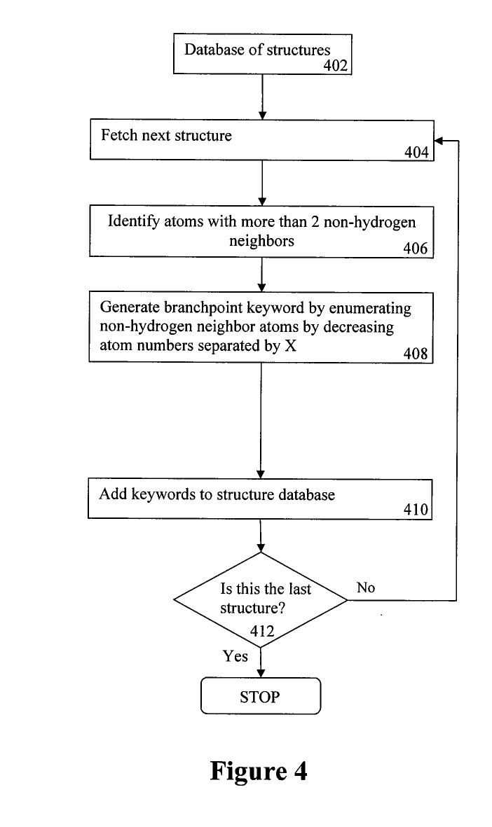

Details of system operations for assigning keywords to branching point structural elements (box 206 of FIG. 2) are illustrated in FIG. 4.

Box 402 of FIG. 4 indicates that the system gains access to the chemical structures database, for processing the database entries in accordance with the invention. As before with FIG. 3, the keyword generation processing is an iterative process in which each structure in the database is accessed in turn, indicated by the fetch operation 404. In the first branching point operation, represented by box 406, atoms in the chemical structure being processed having three or more non-hydrogen neighbors are identified. Then, at box 408, a text string is formed by the atomic symbol of the central atom followed by the neighboring atoms separated by the letter “X”. Single bonds are not written in the string; higher-order bonds are denoted by numbers that precede the atomic symbol of the neighbor atom. The order of the neighbor atoms in the string is determined by their atomic number and by the bond to the center atom; for example, in one embodiment, the system orders the neighbors first by atomic number, with “ties” broken by the number assigned to higher-order bonds. For branch points with four or more neighbors, additional strings are formed by deleting neighbor atoms one at a time and then all combinations of them, and text strings for the resulting branch points are generated. These resulting text strings are the molecular keywords for branch points, which are added to the database incorporating the original chemicals and the corresponding branch point keywords, as indicated by box 410. This processing is carried out for each chemical structure in the database, as indicated by the return path from box 412 to box 404.

An example of the processing illustrated in FIG. 4 is the keyword set that would be generated for branch point processing of alanine, in which the SMILES representation of alanine and the corresponding branch point keyword set are given by: Alanine: SMILES: NC(C)C(═O)O ; keywords: CXCXCXN, CX2OXOXC.

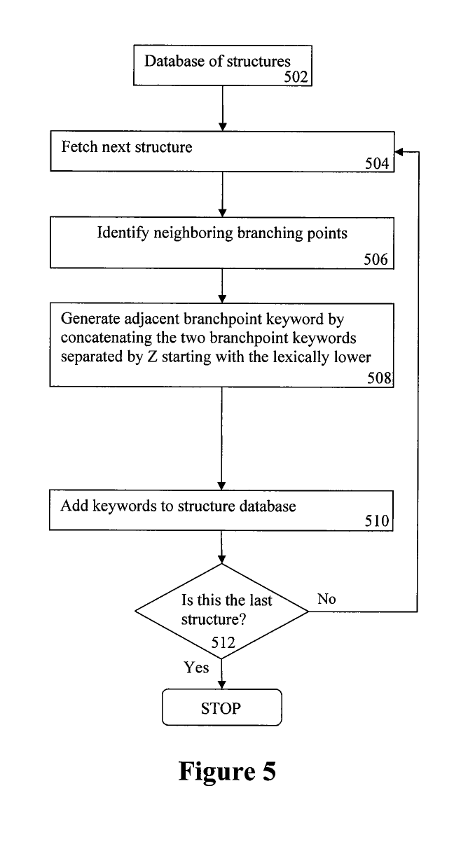

Details of system operations for assigning keywords to pairs of adjacent branching point structural elements (box 208 of FIG. 2) are illustrated in FIG. 5.

Box 502 of FIG. 5 indicates that the system gains access to the chemical structures database for processing the database entries in accordance with the invention. The keyword generation processing is iterative, so that each structure in the database is accessed in turn, as indicated by the fetch next structure operation 504. In the first adjacent branching point operation, represented by box 506, pairs of adjacent central atoms in which each have three or more non-hydrogen neighbors (including the neighbor atom that is one of the pair) are identified. Then, at box 508, for each atom of the pair, a text string is formed beginning with the atomic symbol of the central atom, followed by the atomic symbols of the neighboring atoms, separated by the letter “X”, except that the neighbor atom that is the other atom of the pair is not included. Single bonds are not written in the string; higher-order bonds are denoted by numbers that precede the atomic symbol of the neighbor atom. The order of the neighbor atoms in the string is determined by their atomic number and by the bond to the center atom; for example, an embodiment could order the neighbors first by atomic number, with “ties” broken by the number assigned to higher-order bonds. The two text strings thus formed for each of the pair of atoms are then compared, and the one that is lexically less is written first, followed by the letter “Z”, followed by the text string for the other. If the bond between the two atoms of the pair is not a single bond, then a number is inserted after the Z representing the bond. If either of the two atoms of the pair have four or more neighbors, then additional strings are formed by deleting neighbor atoms one at a time and then all combination of them, and the text strings for the resulting adjacent branch points are generated. These resulting text strings are the molecular keywords for multiple adjacent branch points, and the set of resulting text strings for each chemical structure being processed are added to the database, as indicated by the next operation at box 510. This processing is carried out for each chemical structure in the database, as indicated by the return path from box 512 to box 504.

An example of the processing illustrated in FIG. 5 is the keyword set that would be generated for adjacent branch point processing of alanine, having a SMILES representation and corresponding adjacent branch point keyword set given by: Alanine: SMILES: NC(C)C(═O)O ; keywords: CXCXNZCX2OXO.

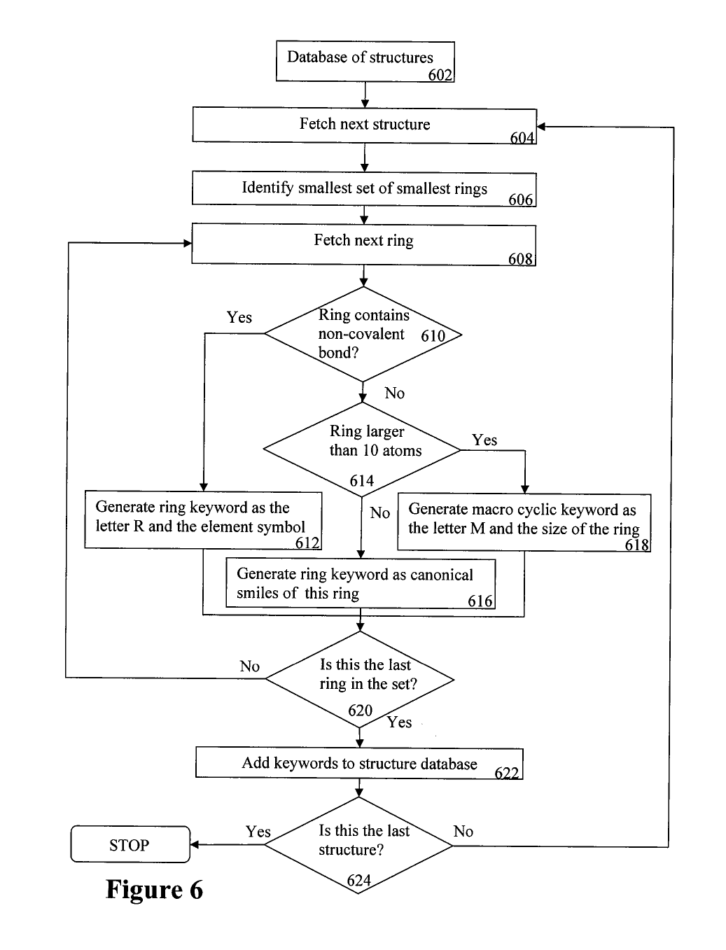

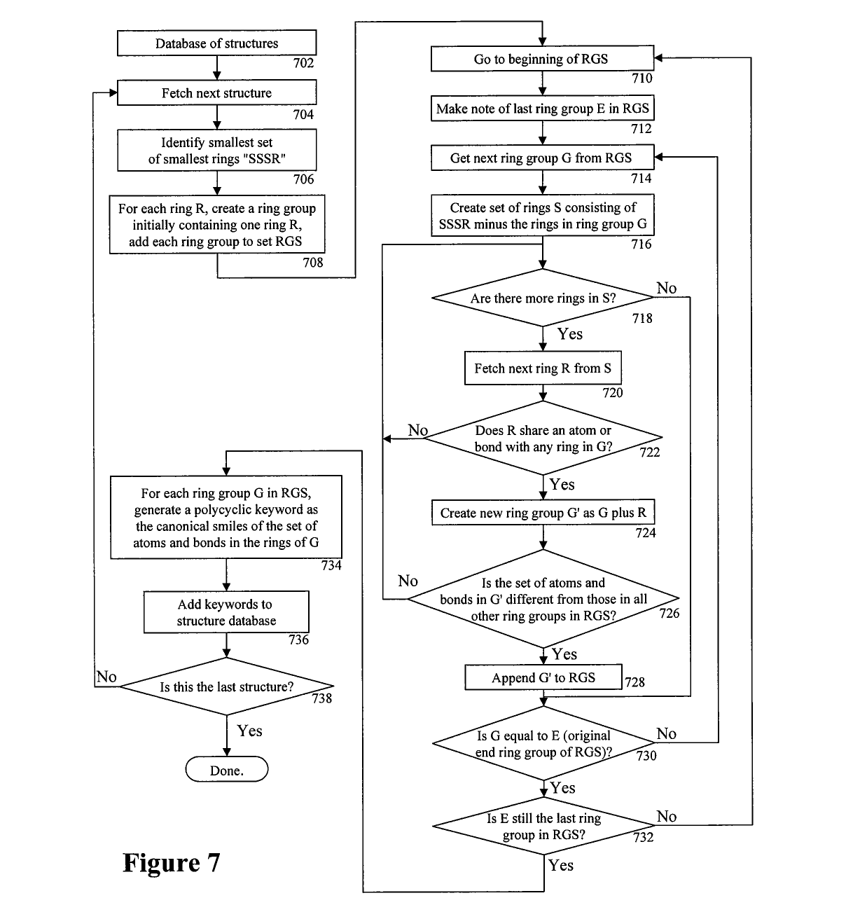

FIG. 6 and FIG. 7 show operations for assigning keywords to cyclic structural elements, both monocyclic (FIG. 6) and polycyclic rings (FIG. 7). These drawing figures correspond to processing of FIG. 2 boxes 210 (FIG. 6) and 212 (FIG. 7).

Box 602 of FIG. 6 indicates that the system gains access to the chemical structures database for processing the database entries in accordance with the invention. The keyword generation processing is iterative, so that each structure in the database is accessed in turn, as indicated by the fetch next structure operation 604. In the first monocyclic operation, represented by box 606, a smallest set of smallest rings (“SSSR”) is identified (see, for example, SSSR, G. M. Downs, V. J. Gillet, J. D. Holliday and M. F. Lynch, J. Chem. Inf. Comp. 29, 172-187, 1989). For each ring in the SSSR, a canonical SMILES string is generated in accordance with known techniques (Morgan, H. L., J. Chem. Doc., 1965, 5, 107-113; Weininger, D., J. Chem. Inf. Comput. Sci., 1988, 28, 31). The ring processing is iterative, so that each ring in the SSSR is accessed in turn, as indicated by the fetch next ring operation 608. In the FIG. 6 processing, however, rings larger than a predefined size, such as ten atoms, are not considered, and rings with non-covalent bonds, such as iron-carbon bonds in ferrocene, are not considered. Thus, at box 610, the system processes the ring to determine if it contains a bond to an atom that is not B, C, N, O, Si, P, S or Se and, if so (an affirmative outcome at box 610), then for each such atom in the ring, the system generates the ring keyword for the database entry as the letter “R” and the corresponding atomic element symbol, as indicated at box 612. If the ring does not contain a non-covalent bond (negative outcome at box 610), at box 614 the system determines if the ring larger than the predefined size. If the ring is larger than the predefined size, an affirmative outcome at box 614, then the system generates a macro cyclic keyword as the letter “M” and the corresponding ring size, as indicated at box 618.

If the ring did not contain a non-covalent bond and was not larger than the predefined size, then processing continues at box 616. At box 616, certain characters in the canonical SMILES, such as brackets “[” and “]”, parentheses “(” and “)”, and percent “%”, are replaced with ordinary alphabetic characters such as “j”, “J”, “q”, “Q” and “v”, respectively, that don't normally occur in a SMILES string, resulting in a text string. In certain cases, this process will result in the same text strings being generated multiple times; in such case duplicate text strings are discarded.

After the processing to generate a ring keyword at box 612, or to generate a macro cyclic keyword at box 618, or to generate a canonical ring keyword at box 616, the same process is carried out for every ring in the SSSR, as indicated by the return path from box 620 to box 608. When the last ring in the SSSR has been processed, then processing continues at box 622. At box 622, the resulting text strings are the molecular keywords for rings, and these molecular keywords for each chemical structure being processed are added to the database. This processing is carried out for each chemical structure in the database, as indicated by the return path from box 620 to box 604.

An example of the processing illustrated in FIG. 6 is the keyword set that would be generated for monocyclic processing of androstenon, having a SMILES reresentation and corresponding monocyclic keyword set given by:

Androstenon:

SMILES: CC34CCC2C(CCC1CC(O)CCC12C)C3CCC4═O
keywords: C1CCC2CCCCC2C1 C1CCC2CQC1qCCC1CCCCC21
C1CCC2CCCC2C1 C1CCC2CQC1qCCC1CCCC21 C1CCCC1 C1CCCCC1
C1CCC2CQC1qCCC1C2CCC2CCCC12

Another example of the FIG. 6 processing is given by the monocyclic processing outcome for diazepam, given by: Diazepam: SMILES: CN3C(═O)CN═C(c1ccccc1)c2cc(Cl)ccc23, keyword: C1=NCCNc2ccccc12 c1ccccc1

Another example of the FIG. 6 processing is given by the monocyclic processing outcome for anthracene, give by: Anthracene: SMILES: c3ccc2cc1ccccc1cc2c3, keyword: C1CC2CC3CCCCC3CC2CC1 c1ccc2ccccc2c1.

Additional details of the FIG. 6 operation for assigning keywords to cyclic structures with non-covalent bonds (box 610) is provided.

First, a smallest set of smallest rings (SSSR) is identified at box 606 and then, at box 608, any atom with a non-covalent bond, such as a Boron bonded to a Hydrogen, or Iron bonded to Carbon, is identified. At box 610, for each ring atom that is not B, C, N, O, Si, P, S or Se, a text string is created beginning with the letter “R”, followed by the element's atomic symbol. No other ring keywords are generated containing such atoms. An example of this processing is given by the following SMILES representation and corresponding keyword set: SMILES: C1CN2CCO[Cu]234(O1)OCCN3CCO4, Keyword: RCu

Additional details of the FIG. 6 operation for assigning keywords to macro cyclic structural elements (box 616) is provided.

First, a smallest set of smallest rings (SSSR) is identified at box 606 and then, at box 608, each ring in the SSSR larger than a predefined size, such as ten atoms, is identified. Then, at box 616, a text string is created beginning with the letter “M”, followed by the number of atoms in the ring. The resulting text strings are the molecular keywords for macro cycles.

An example of this processing is given by the following SMILES representation and corresponding keyword set: Cyclododecane: Smiles: C1CCCCCCCCCCC1, Keyword: M12.

FIG. 7 shows operations for assigning keywords to polycyclic rings, corresponding to box 212 of FIG. 2.

Box 702 of FIG. 7 indicates that the system gains access to the chemical structures database for processing the database entries in accordance with the invention. The keyword generation processing is iterative, so that each structure in the database is accessed in turn, as indicated by the fetch next structure operation 704. In the first polycyclic operation, represented by box 706, a smallest set of smallest rings is identified (see, for example, SSSR, G. M. Downs, V J. Gillet, J. D. Holliday and M. F. Lynch, J. Chem. Inf. Comp. 29, 172-187, 1989) is identified.

Next, at box 708, for each ring R in the SSSR, a “ring group” (a set of rings each of which shares at least one atom or bond with another ring in the set) is created by adding one ring, R, to the ring group, and the ring groups thus formed are put into an ordered list of ring groups called “RGS”. At box 710, an RGS iterator is initialized that, each time it is called, will return the next ring group from RGS. Then at box 712, the last (ending) ring group in RGS is noted, and called “E”.

At box 714, the iterator is called to fetch the next ring group G from RGS, then at box 716, a set of rings S is created by starting with the SSSR, and removing any ring from S that is in G. An S iterator is initialized that, each time it is called, will return the next ring from the set S. Next, at box 718, a test is made to determine if there are more rings in the set S. If the outcome is negative, a “No” outcome of box 718, then control is transferred to the procedures of box 730.

If the outcome is affirmative, a “Yes” outcome of box 71 8, then the next ring R from the set S is fetched at box 720. Next, at box 722, the atoms of R are compared to all rings currently in the ring-group G to determine if R shares any atoms or bonds with rings in G. If the answer is negative, a “No” outcome of box 722, then control returns to box 718. If the answer is affirmative, a “Yes” outcome of box 722, then at box 724 a new ring group, G′, is created by first copying the rings of ring-group G, then adding the ring R to G′.

Next, at box 726, the set of atoms and bonds contained in ring group G′ are compared to every other ring-group in RGS, to determine whether the set of atoms and bonds in G′ are unique. If another ring group in RGS is discovered to contain the exact same atoms and bonds as G′, then the answer is “No”, a negative outcome of box 726, then control is transferred to box 718. If the answer is “Yes”, an affirmative outcome of box 726, then the ring group G′ represents a unique set of atoms and bonds, and at box 728, G′ is appended to RGS.

Next, at box 730, the ring group G tested to see if it is equal to E. If the answer is “No”, a negative outcome of box 730, then control is transferred to box 710. If the answer is “Yes”, then at box 732 the ring-group set RGS is examined to see if E is still the last ring group in the set. If the answer is “No”, a negative outcome of box 732, then control is transferred to box 710. If the answer is “Yes”, a positive outcome of box 732, then all distinct ring groups have been identified and added to RGS, and control continues with box 734.

At box 734, a canonical SMILES string is generated in accordance with known techniques (Morgan, H. L., J. Chem. Doc., 1965, 5, 107-113; Weininger, D., J. Chem. Inf. Comput. Sci., 1988, 28, 31) for the substructure consisting of the atoms and bonds contained in the rings of each ring group of set RGS. Certain characters in the canonical SMILES, such as brackets “[” and “]”, parentheses “(“and ”)”, and percent “%”, are replaced with ordinary alphabetic characters such as “j”, “J”, “q”, “Q” and “v”, respectively, that don't normally occur in a SMILES string, resulting in a text string. In certain cases, this process will result in the same text strings being generated multiple times; in such case duplicate text strings are discarded. The set of resulting text strings for each chemical structure being processed are added to the database, as indicated at box 736.

This processing is carried out for each chemical structure in the database, as indicated by the return path from box 738 to box 704.

Additional refinements can be incorporated into the processing described above for FIG. 7. For example, another embodiment of the present invention limits the total number of polycyclic ring keywords by limiting the size of any ring group added to RGS to a maximum number of rings, such as to a maximum of three rings. In one embodiment of the present invention, an additional box is inserted between boxes 726 and 728 that examines the size of G′ and, if the number of rings in G′ exceeded the limit, control is transferred to box 718, thereby discarding ring groups larger than three rings.

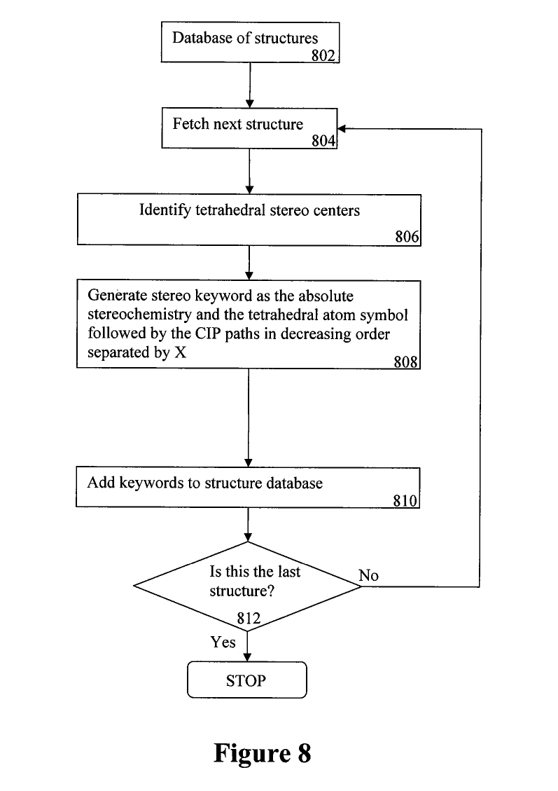

Details of system operations for assigning keywords to stereo center structural elements (box 214 of FIG. 2) are illustrated in FIG. 8.

Box 802 of FIG. 8 indicates that the system gains access to the chemical structures database for processing the database entries in accordance with the invention. The keyword generation processing is iterative, so that each structure in the database is accessed in turn, as indicated by the fetch next structure operation 804. In the first stereo center operation, represented by box 806, any tetrahedral stereo center of the chemical representation being processed is identified. For each identified tetrahedral stereo center, a keyword for the absolute stereochemistry at a given tetrahedral center is generated at box 808. The keyword starts at the atom representing the stereo center and applies the Cahn-lngold-Prelog rules to the neighboring atom by recording the linear path that leads to the decision and sorting them in descending order (A. D. McNaught and A. Wilkinson, IUPAC Compendium of Chemical Terminology, Blackwell Science, 1997). Multiplicity of atoms or multiple bonds are expressed as a count and appended to the path. The different substituents are separated by the letter “X”. The absolute stereochemistry is designated by a leading “S” or “R”. If the fourth substituent is an “H”, the “XH” is omitted. Note that all L-amino acids (except threonine) would have the same stereo keyword. The set of resulting text strings for each chemical representation being processed are added to the database, as indicated by the next operation at box 810. This processing is carried out for each chemical structure in the database, as indicated by the return path from box 812 to 804.

An example of the processing illustrated in FIG. 8 is the keyword set that would be generated for stereo center processing of alanine, having a SMILES representation and corresponding stereo center keyword set give by: Alanine: SMILES: NC(C)C(═O)O ; CIP environment C(N)(CO3)C; stereo keyword: SCXNXCO3XC.

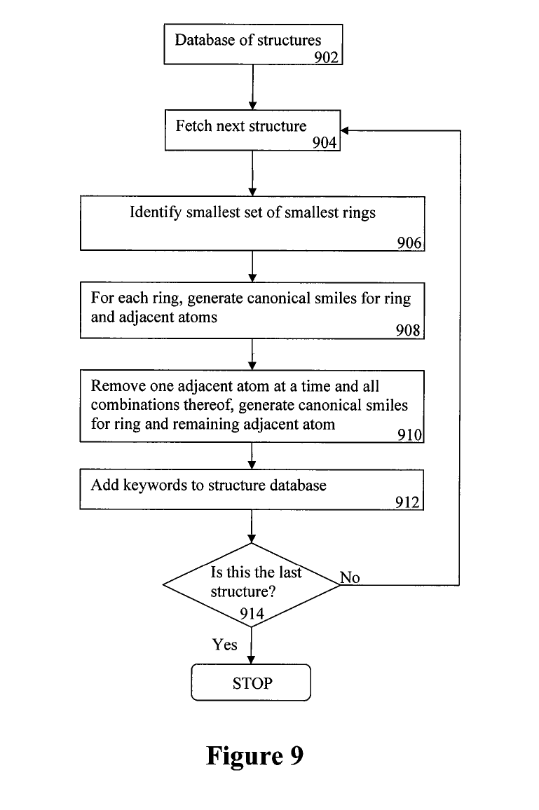

Details of system operations for assigning keywords to ring-substituent pattern structural elements (box 216 of FIG. 2) are illustrated in FIG. 9.

Box 902 of FIG. 9 indicates that the system gains access to the chemical structures database for processing the database entries in accordance with the invention. The keyword generation process is iterative, so that each structure in the database is accessed in turn, as indicated by the fetch next structure operation 904. In the first ring-substituent pattern operation, represented by box 906, a smallest set of smallest rings (SSSR) is identified. Then, at box 908, for each ring in the SSSR, a canonical SMILES representation is created for the ring and all atoms of the molecule that are immediate neighbors of an atom in the ring. Then, at box 910, certain characters in the canonical SMILES representation, such as brackets “[” and “]”, parentheses “(“and ”)”, and percent “%”, are replaced with ordinary alphabetic characters such as “j”, “J”, ^{“q“, “Q” and “v”, respectively, that don't normally occur in a SMILES string, resulting in a text string. The resulting text strings are the molecular keywords for ring-substituent patterns. Additional keywords are added by deleting neighbor atoms (those that are not part of the ring) one at a time and then all combinations of them, and generating the text strings accordingly. The resulting text strings are additional molecular keywords for ring-substituent patterns, and the set of resulting text strings for each chemical representation being processed are added to the database, as indicated by the next operation at box 912. This processing is carried out for each chemical representation in the database, as indicated by the return path from box 914 to box 904.}

An example of the processing illustrated in FIG. 9 is the keyword set that would be generated for ring substituent processing of salicyclic acid, having a SMILES representation and corresponding ring substituent keyword set given by: Salicylic acid: SMILES:Oc1cccc(C(═O)O)c1 keyword: Oc1 ccccqCQc1 .

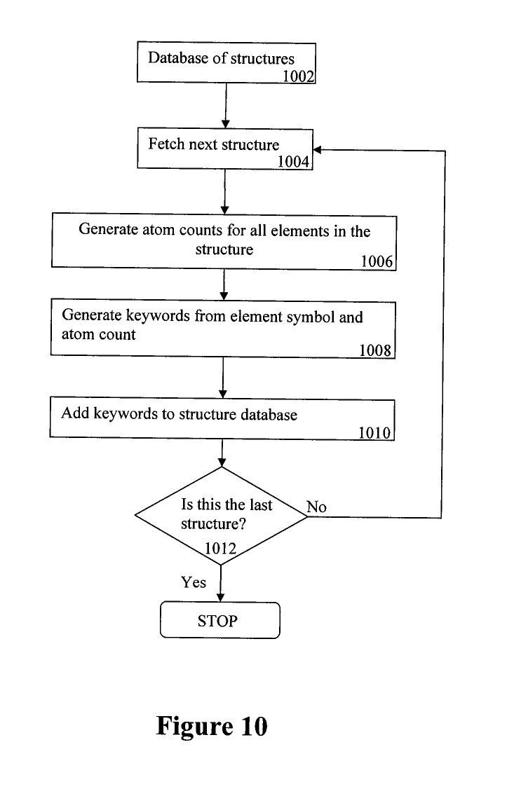

Details of system operations for assigning keywords to molecular formula atom counts (box 218 of FIG. 2) are illustrated in FIG. 10.

Box 1002 of FIG. 10 indicates that the system gains access to the chemical structures database for processing the database entries in accordance with the invention. The keyword generation processing is iterative, so that each structure in the database is accessed in turn, as indicated by the fetch next structure operation 1004. In the first atom count operation, represented by box 1006, for every different element occurring in the structure, an atom count is computed. At box 1008, the molecular keyword is formed from the element symbol and the atom count number. Hydrogen atoms are ignored. Each keyword represents “at least this many atoms” rather than “exactly this many”. For example C5 means “at least five carbons.” The resulting text strings are the molecular keywords for each chemical representation being processed and are added to the database, as indicated at box 1010. This processing is carried out for each chemical structure in the database, as indicated by the return path from box 1012 to box 1004.

An example of the processing illustrated in FIG. 10 is the keyword set that would be generated for atom count processing of C5H6NO2Br, having the formula and corresponding atom count molecular keyword set given by: molecular formula C5H6NO2Br, keywords C1, C2, C3, C4, C5, N1, O1, O2, Br1.

Additional refinements can be incorporated into the processing described above for FIGS. 2-10. For example, another embodiment of the present invention uses statistical techniques for discarding keywords that contribute less to search performance. For linear and ring structures, frequently occurring keywords like short all-carbon keywords are removed. For atom count keywords, those that are relevant are derived from frequency histograms for each element such that the keywords that are employed are only a few percent less selective than the full set of atom-count keywords. For carbon, only C18, C20, C22, C24, C26, C28, and C30 are employed. For nitrogen, only N2, N3, N4, N5 and N6 are employed. A similar statistical technique can be used to discard atom-count keywords for oxygen, fluorine, phosphorus, sulfur, chlorine, bromine and iodine. For all other elements, only the first (e.g. Si1 for silicon) keyword is employed. Such system operation can improve efficiency and reduce response (search) time.

The molecular keywords that are generated as described above can be used for two distinct purposes: creating an index of chemical structures, and querying an index. Without an index of molecular keywords for the database being searched, the system must search through the collection of keywords that correspond to the translated graphical representation of the molecules in the database. Thus, if there is no molecular keyword index, the system will not be able to directly search the index for matches, but must search through the entire collection of keywords, a process that likely will take more time than with an index.

Other efficiency techniques can be used. For example, certain molecular keywords are “contained” by larger keywords, in that the contained molecular keywords are included within the text string of the larger molecular keyword. That is, the presence of the larger containing keyword makes it certain the smaller keyword is present; therefore the smaller keyword is redundant and not needed in the query keywords. For example, the molecule “CCNO” is indexed using the linear structure molecular keywords “CCNO, CCN, CC, CNO, NO”. In contrast, when using “CCNO” as a query, only the keyword “CCNO” needs to be generated since the smaller keywords are contained in it and will always occur if the longest keyword occurs. The contained-by/containing relationship can also occur between different categories of keywords. For example, if a query contains the ring “C1NCSC1“, the system will generate a ring-keyword for that ring, which eliminates the need for the “contained” linear keywords “CNCSC”, “NCSCN”, “NCSC”, and so forth, in the query keywords. In addition, the presence of the ring keyword “C1NCSC1” eliminates the need for the atom-count keywords “S1”, “N1”, “C1” and “C2” because these are all contained by the ring keyword.

An additional embodiment of the present invention uses the molecular keywords generated as described above for indexing and for fast lookup, for example using a hash or tree method for very fast searching of text documents. In another embodiment, the use of a general index search tree method such as “tsearch2/GiST” have proven particularly advantageous (see, for example, the information at the URL of www.sai.msu.su/˜megera/postgres/gist/tsearch/V2/).

In some embodiments, there are three types of structural searches: searches for identical structures or valid tautomers, searches for substructures, and searches for similar structures. These can all be performed by analyzing the structural query and generating molecular keywords that correspond to the molecule or chemical formula provided in the query itself. These query molecular keywords are then used to perform a very efficient indexed text search on the database.

In the case of substructure searching, keywords and text indices can be used to narrow the candidate entries to a smaller, limited, set of molecules, and then search techniques such as the method implemented in OpenBabel (openbabel.sourceforge.net) can be applied to complete the substructure match.

An advantage of the present invention is that many queries, such as “NC(═O)N” or cl nccccl, are fully specified by a single keyword; all molecules returned from the keyword search will in fact match the query, so no atom-by-atom substructure match is necessary.

A keyword search can be used to perform a partial query and estimate the size of the result set, without actually performing a full search over the entire database. For example, after generating the molecular keywords for the query structure, the query keywords can be used to search the index of a randomly-selected subset comprising a portion of the entire database, such as a search of 10,000 rows of the database. Suppose that such a partial search returns 500 molecules (a 5% hit rate). If a substructure match on these 500 molecules is performed, it may be discovered that 40% of the 500 hits actually match. It then can be predicted that 0.05×0.40=2% of the structures in the entire database would likely be returned from a full search using this particular query.

A second method can be used to perform a partial query search over a reduced portion of the database and estimate the size of the result set without performing a full search. In this second method, the rows of the database are “shuffled” or otherwise randomized to ensure that various classes of molecules are spread throughout the rows of the database. That is, the entire database can be shuffled and the reduced portion can be searched, or the database can be left intact while the database rows are processed. If the database is left intact, then the database rows can be processed in random order until the predetermined number of matches are found, or a secondary “shuffle table” can be created that refers to or points to the primary (original) database.

After generating the keywords for the query structure, the keywords are used to search the molecular keyword index and return one molecule at a time; each resulting molecule is then tested with a substructure match. This process continues until a predetermined number of successful matches are found, whereupon the ratio of the number of molecules examined to the total number of molecules in the database can be used to estimate the size of the result set that would be received over the entire database. For example, if we search for the first twenty matches in a database of one million molecules, and the twentieth match is found after searching 50,000 molecules (5% of one million), then we can predict that a complete search over the entire database would result in approximately 20/0.05=400 molecules.

The complete set of molecular keywords can be used as a measure of structural similarity between the query structure and the matching database entry, for example by computing a Tanimoto coefficient using the number of keywords in common divided by the total number of keywords, or measuring Euclidian distance with an N-dimensional space where each dimension's coordinate is 1 or 0 depending on the presence/absence of a keyword. The advantage of this type of similarity search is that it uses the already-computed keywords and indices and therefore is very fast.

Another implementation of similarity searching uses degenerate keywords for indexing each structure in the database and in the query structure. A degenerate keyword represents the presence of any element from a group of elements as a special character or group of characters, e.g. using “Hal” for [F or Cl or Br or I].

Exemplary System

Yet another embodiment of the present invention uses the RDMS PostgreSQL (see the information at the URL of www.postgresgl.org, db.cs.berkeley.edu) and the text indexing tools TSearch2 (see the URL of www.sai.msu.su/˜megera/postgres/gist/tsearch/V2)—which has been modified not to capitalize all letters upon indexing). The chemical information processing is performed using OpenBabel (openbabel.sourceforge.net) referred to above. The exemplary system is implemented on a Dell PowerEdge SC1420 server running the Red Hat Enterprise Linux 4 or Red Hat Fedora Core 3 operating system. Using the example implementation described above and a database of 5.6 million unique chemical structures, typical substructure queries (e.g., for derivatives of penicillin, cephalosporin, fluoroquinolines, flavopiridol, diazepam, phenobarbital, arophylline, or simvastatin) each returned result sets of a few to a few hundred molecules in less than two seconds, as documented in Table 1 below.

TABLE 1

| | | search | |
|---|---|---|---|
| | | time | Number of |
| Name | SMILES of substructure | (seconds) | structures |
| penicillins | CC1(C)S[CH]2[CH](N)C(═O)N2C1C(═O)O | 0.8 | 220 |
| cephalosporins | NC1C(═O)N2C(C(═O)O)CCSC12 | 1.2 | 5 |
| fluoroquinolones | OC(═O)c1cn(C2CC2)c3cc(N4CCNCC4)c(F)cc3c1═O | 1.2 | 490 |
| flavopiridol | Cc1c(O)cc(O)c2c(═O)ccoc12 | 0.8 | 640 |
| diazepam | CN3C(═O)CN═C(c1ccccc1)c2cc(Cl)ccc23 | 1.3 | 220 |
| phenobarbital | O═C2NC(═O)C(c1ccccc1)C(═O)N2 | 1.7 | 350 |
| arophylline | CN2C(═O)C1NC═NC1N(C)C2═O | 1.3 | 56 |
| simvastatin | C3═CC1═CCCCC1C(CCC2CCCCO2)C3 | 0.8 | 52 |

The present invention is compatible with a broad range of database systems, hardware systems and software tools and, hence, is cross-functional and widely applicable. It is well known to those of ordinary skills in the computer science field that the Linux operating system is available for a wide variety of hardware, so it can be implemented on most modern computer systems, including, but not limited to servers, workstations, desktops and laptops based on Intel processors like Pentium, Xeon or Itanium or on AMD processors like Athlon, Sempron, Turion or Opteron, or processors from other vendors like IBM or Sun. PostgreSQL can also be implemented on other computers running a variety of Unix operating systems, or a Windows NT or XP operating system. The present invention can also be implemented on a different RDBMS with text search capabilities, like Oracle. Since Oracle and the other RDBMS are available for almost any computer platform, the present invention could also be implemented on any of those platforms.

Some preferred embodiments of the present invention use a web browser (e.g. MS Internet Explorer, Netscape, Firefox, Opera) for user interaction on the user's workstation, desktop or laptop communicating over a LAN or WAN network. The user specifies the query criteria by drawing a chemical structure using a structure drawing program like JME, ISIS-Draw, ChemSketch or ChemDraw, transferring a MOL file or entering a SMILES or SMART string into the browser window, or a helper application or plug-in. The server executes the query and returns a table of results with the graphical representation of the hit structure and associated textual or graphical data. The user is then led to retrieve additional information by following web links to other data sources, either on the world wide web or an intranet.

High-Performance Text Index

In some embodiments, the present invention can be implemented to create a high-performance index of the words in a text document (a “text index”), and allow rapid identification and retrieval of all documents that contain all of the words in a query. For chemical databases, these words are molecular keywords, and each “text document” is the collection of molecular keywords for one molecule.

A large chemical database typically contains tens or hundreds of thousands of distinct molecular keywords. For example, one chemistry database of 5.6 million unique chemical structures contained 326,350,774 molecular keywords, from a “vocabulary” of 107,072 distinct molecular keywords.

An important fact about molecular keywords is that most keywords in a typical chemistry database occur in just one molecule; a small fraction (typically one percent or less) of the molecular keywords occur in two to twenty molecules, and another small fraction (typically one percent) of the molecular keywords occur in more than twenty molecules, and a few of the molecular keywords occur in a large fraction or most of the molecules.

Another important fact is that most chemists enter queries that will return a small fraction of the molecules in a database, typically much less than one percent of the entire database. This means that the index must be very efficient at rejecting rows that will not match, since the vast majority of rows will be rejected. Thus, the more quickly the system can reject rows, the faster the system will be.

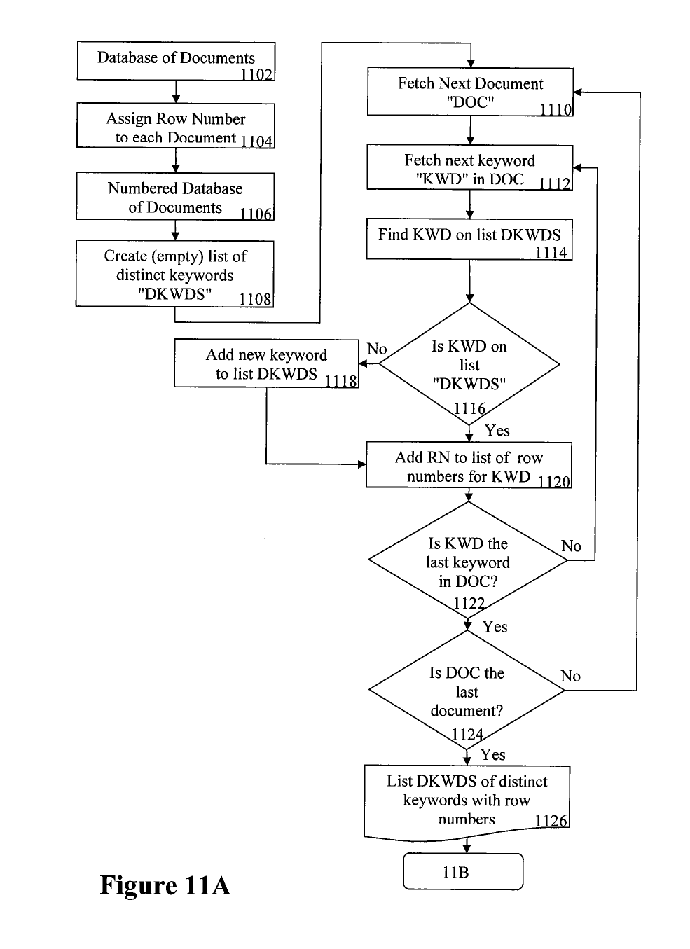

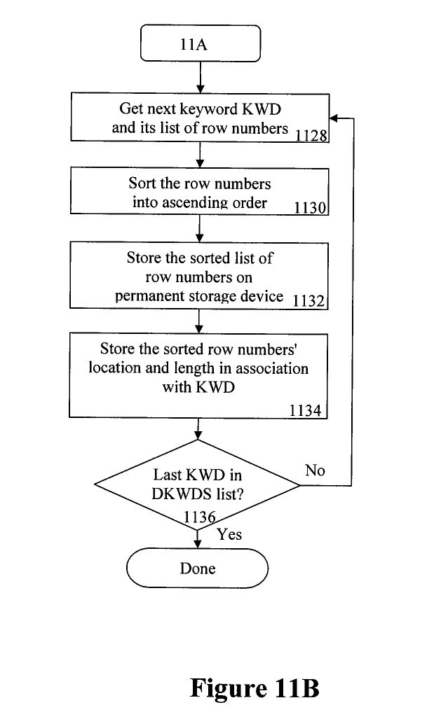

Embodiments of the present invention can be used to create an index of the keywords in a database. The operations performed in creating the keyword index are illustrated through the following procedures shown in the flow diagram of FIG. 11A and FIG. 11B.

Box 1102 of FIG. 11A indicates that the system gains access to the chemical structure document keyword database for processing the keywords and generating an index. The next operation, box 1104, is for the system to assign a row number to each document in the database. The system assigns a distinct integer (the “row number”) to each molecule in the database using a monotonically ascending integer sequence that begins with the number one. This results in a numbered database of documents (box 1106).

Next, the system identifies unique keywords in the document keyword database. To perform this operation, indicated at box 1108, the system first creates a list of distinct keywords, cycling through each document (box 1110) and each keyword in each document (box 1112). In this way, the system scans all documents in the database and identifies all unique keywords in the database; that is, it identifies the “vocabulary” of words that occurs in the database. The system does this by checking each potential new keyword (“KWD”) against the processed list of keywords (“DKWDS”) at box 1114, and if the new keyword KWD is not on the list, a negative outcome at box 1116, then at box 1118 the new keyword KWD is added to the list of keywords.

The system also maintains a list of keyword occurrences. Therefore, if at box 1116 the system determines that the keyword KWD is already on the list, an affirmative outcome at box 1116, or if the keyword KWD is added to the list at box 1118, the system adds the row number of the KWD entry to a running count of the occurrences of KWD in the processed list of keywords DKWDS. That is, the system notes the row numbers in which each distinct keyword occurs, and for each distinct keyword, the resulting list is recorded and associated with that keyword for later retrieval. This processing continues for all entries in a document and for all keywords in the document, as indicated by the return path from box 1122 and box 1124 to box 1110 and 1112. This processing generates a list DKWDS of distinct keywords with corresponding row numbers and occurrence counts, as indicated at box 1126. The processing for creating the keyword index then continues with the operations illustrated in FIG. 11B.

As indicated by box 1128 of FIG. 11B, the system operates on the list DKWDS of distinct keywords, so that at box 1130 each such list is sorted into numerically-ascending order. After sorting, each sorted list of row numbers is written to the computer's permanent storage system. This processing is represented by box 1132.

Next, as indicated by box 1134, the system records summary information for each list. The system does this by creating summary information about each sorted list, such as the number of row numbers in the list, and the list's location on the computer's permanent storage system. This information is associated with the corresponding molecular keyword and stored in the database for fast retrieval. These operations are carried out for each keyword in the list, as indicated by the return path from box 1136 to box 1128.

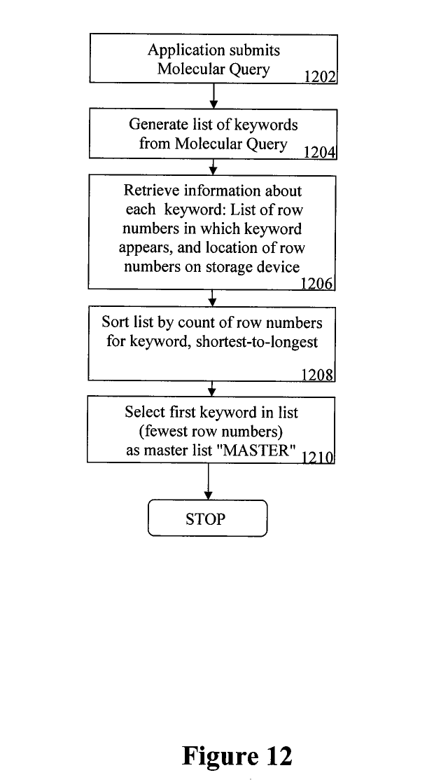

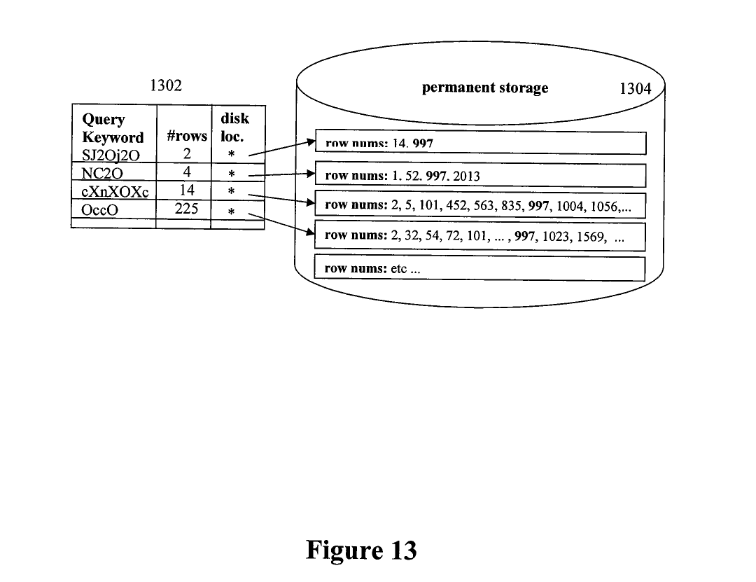

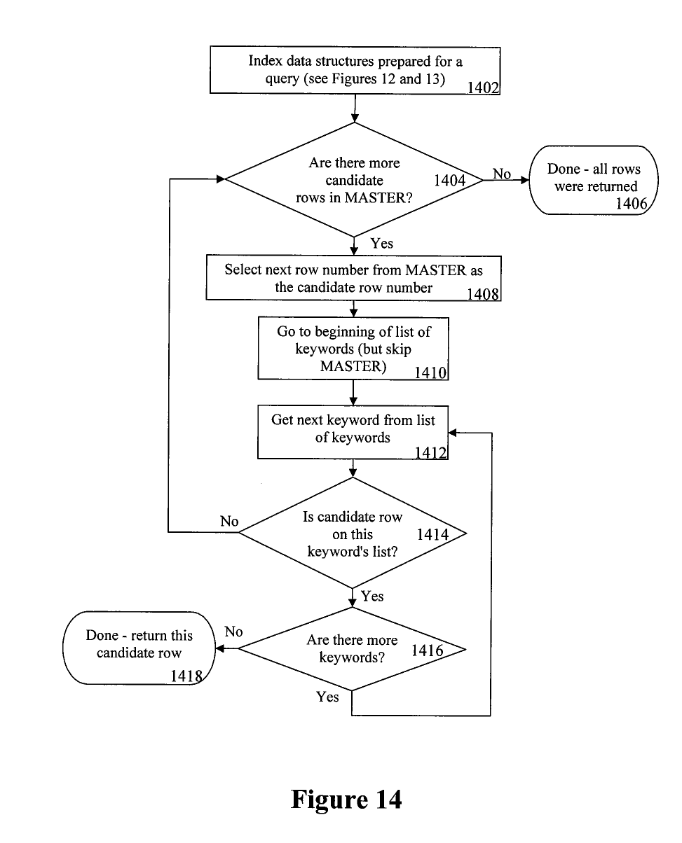

After the index is prepared as described above, it is ready to be searched. When a user submits a query, the system prepares the database entries prior to returning any answers. This operation is illustrated in the flow diagram of FIG. 12.

The query processing begins when an application, such as a Web browser, is used to submit a molecular search query against the database (box 1202). The query molecule is analyzed and a list of molecular keywords is generated that corresponds to the molecule or formula of the query, as indicated at box 1204. Note that the keywords are specific to the query operation as described above in connection with FIG. 8.

Next, at box 1206, the system retrieves information about each keyword generated for the query, such as the size and storage location of each of the row-number list associated with each keyword of the query generated as described above. The system then sorts the keywords by comparing the number of row numbers in each list, such that the keywords with the shortest list of row numbers (least rows) are first, and the keywords with the longest list row numbers (greatest number of rows) are last. This causes the rarest keywords to be ordered first and the most-common keywords to be ordered last. This processing is represented by box 1208.

The first keyword in the list of keywords (the “rarest” keyword with the fewest row numbers) is identified, and its corresponding list of row numbers is called the “master list.” An iterator is created that, on the first call, will return the lowest row number from the master list, and on each subsequent call will return the next-higher row number from the master list. This processing is represented by box 1210.

By sorting (box 1208) and identifying the master list (box 1210), the keyword lists are ordered such that candidate row numbers are rejected as early and quickly as possible, as described above.

After the procedures described above in connection with FIG. 11A and FIG. 11B, the keyword index is ready to be searched. To commence the actual search, the application program issues a series of requests for a row number. In response to each request, the system identifies and returns the next row number that contains all of the molecular keywords of the query molecule. The structure of the keyword database is illustrated in FIG. 13, and operations to identify and return the appropriate row numbers is illustrated in the flow diagram of FIG. 14.

FIG. 13 shows data structures that have been built from the molecular keywords during the creation of the molecular keyword index, as illustrated in FIG. 12. In FIG. 13, a particular query has generated a corresponding set of keywords 1302 indicated as SJ2Oj2O, NC2O, cXnXOXc, and OccO. The molecular keyword data structures 1304 in the system storage show that the index row entry for row 997 includes all of the keywords in the query, as indicated by the pointers from the query keyword list to the locations of row numbers in the index database 1304.

FIG. 14 illustrates the operations performed by the system to return the appropriate row number that matches the query, as described above. The system first processes the query request after the index data structures have been prepared for a query, as indicated at box 1402. First, the system processes the entries in the master list and identifies a next candidate row in the master list, as indicated by box 1404. If there are no more candidate rows to process, a negative outcome at box 1404, the index query processing is complete. The system otherwise processes the identified candidate row by selecting the next row number from the master list as the next candidate row number (box 1408). That is, the master list's iterator is called to get the next “candidate” row number. If the master list's iterator reaches the end of the master list (there are no more candidates), then all matching rows have been returned and the search is complete. Thus, if the end of the list of keywords is reached (all have been searched and found to contain the candidate row), the candidate row matches the query, and it is returned to the application program at box 1406.

More particularly, the keyword list is processed, beginning at the start of the list (box 1410) and continuing for each keyword in the list (box 1412). The next keyword in the sorted list of keywords is selected. At box 1414, each candidate row is searched against the keyword's list of row numbers to determine if it contains the candidate row number. If the candidate row number is found on this list, an affirmative outcome at box 1414, then at box 1416 the system checks for additional keywords to process and, if additional keywords remain, processing returns to box 1412 to get the next keyword and continue processing. If the candidate row is found on the list but no more additional keywords remain for processing, then processing is complete and the system returns the candidate row as a query match (box 1418). If the candidate row number is not found on this keyword list, a negative outcome at box 1414, then the candidate row is rejected (it does not match any of the query molecule's keywords), and the procedure returns to box 1404 to process the next candidate row.

In some embodiments of the system, the search processing described above is made more efficient as follows. Since all of the lists of row numbers are sorted, a variety of well-known techniques, such as b-trees, a binary search, or for short lists, a simple linear search (Knuth, D., The Art of Computer Programming, Volume 3, 473-479 and 506-549 (Addison-Wesley 1973)) can be used to quickly discover whether a candidate row number is on a particular list. However, for a second or subsequent candidate row number, it is guaranteed that the candidate row number will be greater than the previous candidate; therefore, the search of the list need not consider any values less than the previous candidate and the search can be correspondingly faster. Accordingly, a mechanism is added to each list of row numbers that records where the last search for a candidate molecule succeeded or failed, and this information is used when the next candidate row is considered.

If, at some point in the search, the application has retrieved enough results, for example if it has obtained a complete page, the “state” of the index can be saved by storing only the row number of the most-recently-returned molecule. This small amount of state information can be stored, for example as a “cookie” on the user's web browser. On a subsequent invocation of the application program, the index's state can be restored with just this single row number, and the search for the next page of results can recommence immediately.

A fact about a molecular keyword index is that “false positives” are acceptable; that is, it is permissible for the index to return row numbers that will later be rejected because the query molecule is not a substructure of the candidate molecule. If too many false positives are returned, performance is adversely affected, but a small number of false positives is acceptable if the index's performance is thereby improved.

Molecular keywords for a particular molecule are not randomly distributed amongst the “vocabulary” of keywords in the database. Instead, they tend to be clustered into groups of related keywords. For example, the presence of a pyridine ring (SMILES: n1ccccc1) makes it far more likely that branch-point keywords containing aromatic carbon and/or nitrogen (e.g. for the partial structure “cc(C)c”) will occur. As another example, the presence of the molecular keyword “O1” indicating the presence of oxygen makes it very likely that one of the linear molecular keywords “CO” or “cO” will occur. In such cases, the presence of both keywords in the list of keywords may not add to the selectivity of the index; that is, in some instances the system might discard one of the molecular keywords without significantly affecting the results. If a keyword is thus discarded, the index may return more “false positives” as described above.

The procedures described above in connection with FIG. 11A and FIG. 11B provide a heuristic that generally yields good search performance based on the statistical likelihood that rare keywords will quickly reject candidate rows (per the discussion above). An additional heuristic technique takes advantage that certain keywords are anti-correlated in the sense that individually each keyword may be common, but a specific combination of keywords may be rare.

In one embodiment of the current invention, performance is improved by the following procedures. First, statistics about the candidate row searching are kept. As described above, for each candidate row number, lists are searched in a particular, predefined order, and when a particular list is found that doesn't contain a candidate row number (the search “fails”), the search halts and the rest of the lists are not searched. During this process, a count is kept for each list, recording how many times each list produced a failure.

Next, after each candidate row is examined, the list counts described immediately above are examined. If any keyword has twice as many “failures” as the keyword preceding it in the list of keywords, then the positions of the two keywords are switched in the list. After each candidate row is examined beyond the first twenty, the list counts referred to above are examined. If any keyword has zero failures (it has contained every candidate keyword), then that keyword is removed from the list of keywords and is not used for the duration of the procedure.

The procedures of the preceding paragraphs have the effect of separating groups of correlated keywords, such that more selective keywords (those that fail the most) are moved to the front of the list, and of removing keywords that are highly correlated with other keywords in the query and thus not increasing the index's selectivity. In one experiment, typical queries for organic molecules were represented by twenty to one hundred molecular keywords. Applying the heuristic procedures of the preceding paragraph, after several thousand candidate row numbers were examined, the procedures had typically removed all but eight to twelve of the molecular keywords, leaving the most highly selective and the most “anti-correlated” keywords. The resulting keywords were in all cases nearly as selective as the original set of keywords, with very few additional “false positives.”

If, at some point in the search, the application has retrieved enough results, for example if it has obtained a complete page, it is desirable to store the “state” of the index as described above. Since the heuristic procedure described immediately above has altered the state, it is necessary to store additional information. In one embodiment of the present invention, each molecular keyword is assigned an integer identifier, and the integers associated with the keywords remaining after the output of the heuristic procedures above are written as ASCII text into a string. This short text string (typically a few dozen bytes) is then saved by the user application submitting the query, for example by transmitting the text string to the user's browser as a “cookie.” On a subsequent invocation of the application program, the index's state can be restored by retrieving the “cookie” from the user's web browser and rebuilding the list of keywords. The search for the next page of results can recommence using the optimized list of keywords.

An advantage of a system implemented in accordance with the present invention is that it is very fast at identifying molecules that contain all of the molecular keywords in a particular query. In particular, the search time of the index is proportional to the log₂(N) where N is the length of the shortest list of row numbers in the molecular keywords of the query. In the case where N is large, the present invention dynamically discovers correlations and anti-correlations between the keywords, and dramatically reduces time required to search the index.

Another advantage of a system implemented in accordance with the present invention is that it is well suited to web-browser applications and other application programs that retrieve partial results in “pages,” for two reasons. First, the index returns molecules one at a time, rather than in large result sets, so the application can retrieve the exact rows needed for a single page of results, without any wasted computations. And second, the “state” of the index can be saved using a small text string, for example as a “cookie” in a web browser, and this state can later be easily restored. This means that when retrieving the second and subsequent pages of results, there is no significant lost effort associated with restoring the index and continuing the search.

Canonical SMILES for Molecular Fragments

Application programs for chemistry occasionally have a need for canonical SMILES strings that represent molecular fragments (herein called a “partial canonical SMILES”), rather than a whole molecules. See, for example, Weininger, D., J. Chem. Inf. Comput. Sci., 1988, 28, 31; Weininger, D., J. Chem. lnf. Comput. Sci., 1989, 29, 97-101; Morgan, H. L., J. Chem. Doc., 1965, 5, 107-113. For example, in the exemplary systems described thus far, the procedures to generate molecular keywords for groups of adjacent rings create a partial canonical SMILES for each of the molecular fragments consisting of the atoms and bonds in a set of adjacent rings.

Most established methods for generating partial canonical SMILES representations attempt to apply the canonicalization procedures designed for complete molecules to a molecular fragment, by creating a “molecule” that consists of just the fragment's atoms and bonds. However, this presents difficulties, because the electronic state (hybridization, number of neighbors, number of attached hydrogens) of the atoms in a fragment of a molecule is difficult to ascertain. For example, in the linear fragment consisting of O—C—C—O in 1,2-dihydroxybenzene, SMILES: Oc1c(O)cccc1, it is difficult to deduce that the two carbon atoms are aromatic without the complete ring environment. Established methods must use a variety of techniques to emulate the electronic environment of the atoms in the fragment.

The exemplary embodiments described herein represent molecular fragments by using the full molecule, and additionally maintaining a list of atoms and bonds that are in the molecular fragment. When the fragment-canonicalization procedures compute graph invariants and symmetry classes for each atom and bond of the fragment (see Morgan and Weininger above), each atom's full electronic state, such as the number of neighbors, the bond order of each bond, and the number of attached hydrogens, is fully known because the molecule is fully represented. When the canonicalization procedures compute symmetry classes, and ultimately write the partial canonical SMILES, the procedures only consider those atoms and bonds that are in the molecular fragment.

An advantage provided by the present invention is that partial canonical SMILES can be accurately generated for arbitrarily complex fragments of a molecule.

It is a further advantage provided by the present invention that partial canonical SMILES can be created for many different molecular fragments of the same molecule, by simply creating a new list of atoms and bond for each fragment. The procedures do not have to recreate the full data structure of atoms and bonds for each fragment, but rather can reuse the existing data structure representing the molecule, thereby improving performance.

System Implementation

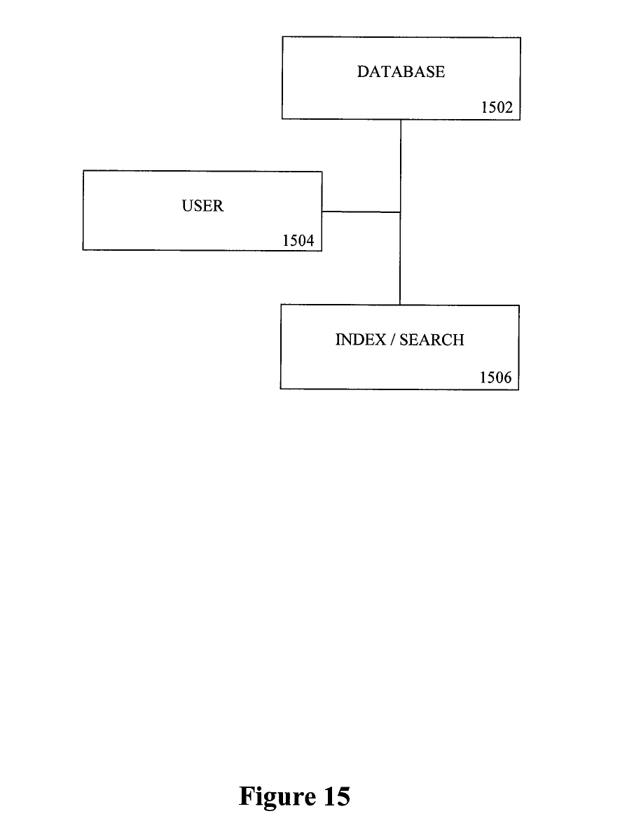

Systems that implement the features and operations described above can have a variety of configurations. As noted above, such systems can include a broad range of database systems, hardware systems, and software tools. An exemplary configuration of a system that implements these features and operations is illustrated in FIG. 15.

FIG. 15 shows that a database of molecular representations 1502 communicates with a user 1504 who submits search queries to an index/search subsystem 1506. The database 1502, user 1504, and index/search subsystem 1506 can be independent processing systems, or can be integrated into a single device, or can be a combination of such configurations. The illustrated index/search subsystem 1506 is shown separate from the database, but either the search function or the optional index function may be performed (and integrated into) the user system 1504 or the database system 1502. In general, the three elements 1502, 1504, 1506 will usually comprise separate computing devices that communicate over a network, such as the Internet or a local area network or the like.

A user 1504 will generally operate a Web browser or similar network-capable application to submit a query to the index/search system, which may comprise a server that operates a Web site or similar network processing location. The index/search system will then gain access to the database 1502 to carry out the submitted query. If desired, the database can incorporate keyword indexing files, so that indexing need not be performed at the time of receiving a query, but rather can be performed in advance of query requests.

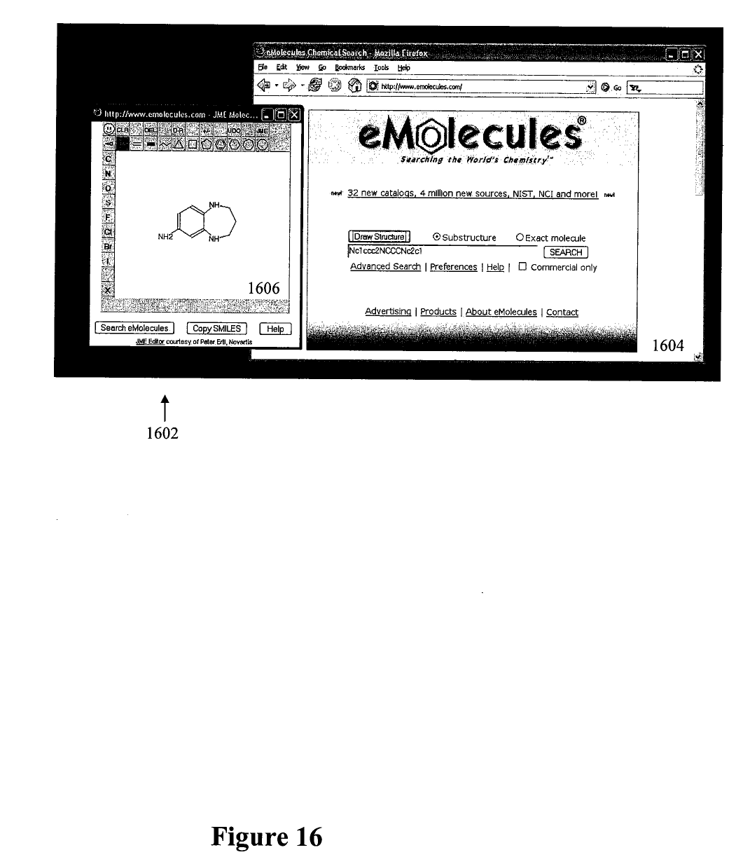

FIG. 16 is an illustration of a computer display 1602 showing processing at a user computer in accordance with the invention. The right-hand side of FIG. 16 shows a Web browser application window 1604 for a Web site identified as “eMolecules”, operated by the assignee of all rights in the present invention. The left-hand side of the display 1602 also shows a graphic window 1606 showing a representation of an exemplary query search molecule. The corresponding formula is shown in the Search box of the application 1604 as “Nc1ccc2NCCCNc2c1”.

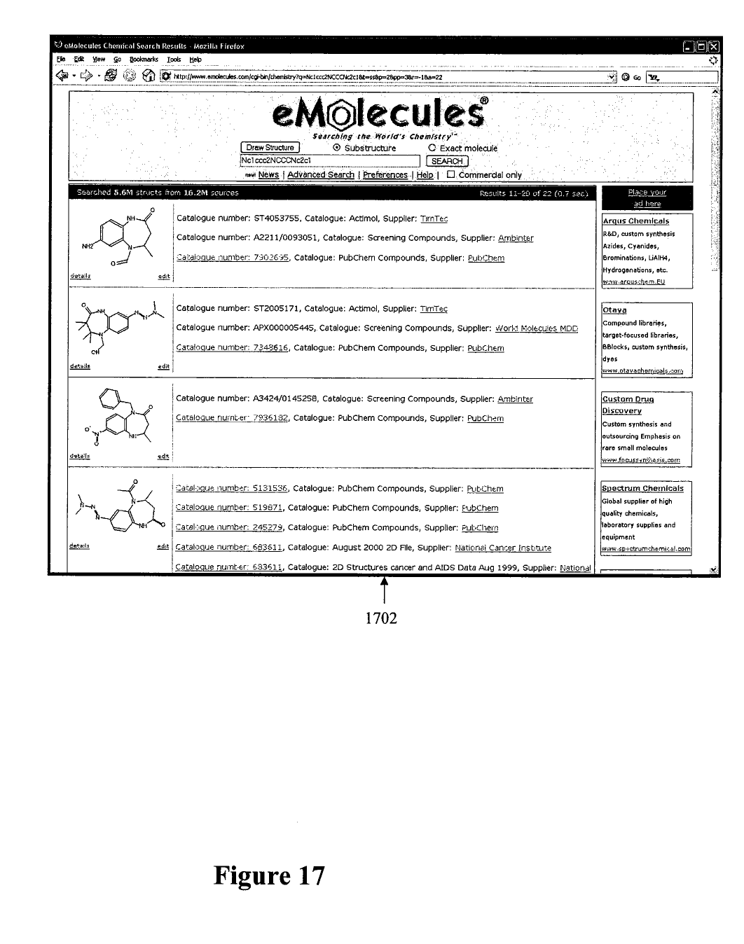

FIG. 17 is an illustration of a computer display 1702 at a user computer, showing the outcome of the search query illustrated in FIG. 16. The display shows the query molecular formula in the Search box of the “eMolecules” Web site, with four exemplary results located in the searched database. Exemplary advertisements for sponsors of the Web site are illustrated on the right-hand side of the display 1702. The display indicates that, for this query and for this database, twenty-two search results were identified in 0.7 seconds from a search of 5.6 M structures over 16.2 M sources.

The present invention has been described above in terms of a presently preferred embodiment so that an understanding of the present invention can be conveyed. There are, however, many configurations for database systems not specifically described herein but with which the present invention is applicable. The present invention should therefore not be seen as limited to the particular embodiments described herein, but rather, it should be understood that the present invention has wide applicability with respect to database systems generally. All modifications, variations, or equivalent arrangements and implementations that are within the scope of the attached claims should therefore be considered within the scope of the invention.

We claim:

1. A computer method for processing a database, the method comprising:
(a) accessing a database containing data representing a plurality of chemical structures;
(b) generating a set of molecular keywords associated with each chemical structure representation in the database, wherein each molecular keyword of a set of molecular keywords corresponds to a structural feature of the associated chemical structure representation.

2. The computer method as defined in claim 1, wherein generating a set of molecular keywords comprises:
(1) determining if the data representation of each chemical structure matches one or more of the structural features;
(2) generating one or more text symbols for each of the matched specified structural features of the chemical structure representation.

3. The computer method as defined in claim 2, further including:
adding the text symbols to a keyword record in a structure database for the chemical structure.

4. The computer method as defined in claim 3, wherein the chemical structure representations in the database are stored in accordance with a chemical representation protocol, and wherein the added text symbols include text symbols that would otherwise not be permitted by the chemical representation protocol.

5. The computer method as defined in claim 1, further including:
producing an index that identifies the molecular keywords associated with each of the chemical structures in the database for each of the structural features.

6. The computer method as defined in claim 1, wherein the structural features include one or more from the set of features comprising linear structures, branching points, adjacent branching points, cyclic structures, stereo centers, ring substituent patterns, and atom counts.

7. The computer method as defined in claim 1, wherein the molecular keywords indicate any substructures that are present in the chemical structure representation.

8. The computer method as defined in claim 1, wherein generating a set of molecular keywords for a chemical structure representation that has no structural features comprises generating a default molecular keyword character.

9. The computer method as defined in claim 1, further including:
(a) receiving a chemical structure search query that relates to the chemical structures database;
(b) generating a set of molecular keywords for each chemical structure in the search query, wherein each molecular keyword of the set of molecular keywords corresponds to a structural connectivity feature of the search query;
(c) identifying chemical structure representations in the database, wherein each chemical structure in the database is associated with a set of molecular keywords such that each molecular keyword of a set of molecular keywords corresponds to a structural connectivity feature of the chemical structures database, and wherein the identified database chemical structures are those database chemical structures whose molecular keywords are a superset of the search query molecular keywords.

10. The claim as defined in claim 9, further including:
producing an index that identifies the molecular keywords associated with each of the chemical structures in the database for each of the structural features; and
wherein identifying database chemical structures whose molecular keywords are a superset of the search query molecular keywords comprises comparing the molecular keywords of the search query with the molecular keywords of the index.

11. The computer method as defined in claim 10, wherein identifying database chemical structures comprises:
performing a partial search query on a portion of the chemical structures database, and
generating an estimate of the size of the search query over the entire chemical structures database.

12. The computer method as defined in claim 10, wherein the molecular keywords of the molecular keyword index comprise every possible permutation for each atom within each structural connectivity feature.

13. The computer method as defined in claim 10, further comprising:
identifying a chemical compound within the chemical structures database that is identical to the query chemical structure, identical to a tautomer of the query chemical structure, identical to a superstructure of the query chemical structure, or similar to the query chemical structure.

14. A computer method for processing a search query, the method comprising:
(a) receiving a search query that relates to a database containing data representing a plurality of chemical structures;
(b) generating a set of molecular keywords for each chemical structure in the search query, wherein each molecular keyword of a set of molecular keywords corresponds to a structural connectivity feature of the search query chemical structure;
(c) identifying chemical structures in the database, wherein each chemical structure in the database is associated with a set of molecular keywords such that each molecular keyword of a set of molecular keywords corresponds to a structural connectivity feature of the database chemical structure, and wherein the identified database chemical structures are those database chemical structures whose molecular keywords are a superset of the search query molecular keywords.

15. The computer method as defined in claim 14, wherein identifying chemical structures in the database comprises comparing the search query molecular keywords to an index that identifies the molecular keywords associated with each of the chemical structures in the database for each of the structural features.

16. The computer method as defined in claim 14, wherein the structural features include one or more from the set of features comprising linear structures, branching points, adjacent branching points, cyclic structures, stereo centers, ring substituent patterns, and atom counts.

17. The computer method as defined in claim 14, wherein the molecular keywords indicate any substructures that are present in the chemical structure.

18. The computer method as defined in claim 14, wherein identifying database chemical structures comprises:
performing a partial search query on a portion of the chemical structures database, and
generating an estimate of the size of the search query over the entire chemical structures database.

19. The computer method as defined in claim 14, further comprising:
identifying a chemical compound within the chemical structures database that is identical to the query chemical structure, identical to a tautomer of the query chemical structure, identical to a superstructure of the query chemical structure, or similar to the query chemical structure.

20. A computer apparatus that processes a database, the apparatus comprising:
(a) database access means for accessing a database containing data representing a plurality of chemical structures;
(b) a processor that generates a set of molecular keywords associated with each chemical structure representation in the database, wherein each molecular keyword of a set of molecular keywords corresponds to a structural connectivity feature of the associated chemical structure representation.

21. The computer apparatus as defined in claim 20, wherein the processor generates a set of molecular keywords by (1) determining if the data representation of each chemical structure matches one or more of the structural features and (2) generating one or more text symbols for each of the matched specified structural features of the chemical structure representation.

22. The computer apparatus as defined in claim 21, wherein the processor adds the text symbols to a keyword record in a structure database for the chemical structure.

23. The computer apparatus as defined in claim 22, wherein the chemical structure representations in the database are stored in accordance with a chemical representation protocol, and wherein the added text symbols include text symbols that would otherwise not be permitted by the chemical representation protocol.

24. The computer apparatus as defined in claim 20, wherein the processor produces an index that identifies the molecular keywords associated with each of the chemical structures in the database for each of the structural features.

25. The computer apparatus as defined in claim 20, wherein the structural features include one or more from the set of features comprising linear structures, branching points, adjacent branching points, cyclic structures, stereo centers, ring substituent patterns, and atom counts.

26. The computer apparatus as defined in claim 20, wherein the molecular keywords indicate any substructures that are present in the chemical structure representation.

27. The computer apparatus as defined in claim 20, wherein the processor generates a set of molecular keywords for a chemical structure representation that has no structural features comprises generating a default molecular keyword character.

28. The computer apparatus as defined in claim 20, wherein the processor further performs operations including:
(a) receiving a chemical structure search query that relates to the chemical structures database;
(b) generating a set of molecular keywords for each chemical structure in the search query, wherein each molecular keyword of the set of molecular keywords corresponds to a structural connectivity feature of the search query;
(c) identifying chemical structure representations in the database, wherein each chemical structure in the database is associated with a set of molecular keywords such that each molecular keyword of a set of molecular keywords corresponds to a structural connectivity feature of the chemical structures database, and wherein the identified database chemical structures are those database chemical structures whose molecular keywords are a superset of the search query molecular keywords.

29. The computer apparatus as defined in claim 28, wherein the processor further performs operations including:
producing an index that identifies the molecular keywords associated with each of the chemical structures in the database for each of the structural features; and
wherein identifying database chemical structures whose molecular keywords are a superset of the search query molecular keywords comprises comparing the molecular keywords of the search query with the molecular keywords of the index.

30. The computer apparatus as defined in claim 29, wherein the processor identifies database chemical structures by performing a partial search query on a portion of the chemical structures database, and generating an estimate of the size of the search query over the entire chemical structures database.

31. The computer apparatus as defined in claim 30, wherein the molecular keywords of the molecular keyword index comprise every possible permutation for each atom within each structural connectivity feature.

32. A computer apparatus for processing a search query, the apparatus comprising:
(a) query means for receiving a search query that relates to a database containing data representing a plurality of chemical structures;
(b) a processor that processes the search query and generates a set of molecular keywords for each chemical structure in the search query, wherein each molecular keyword of a set of molecular keywords corresponds to a structural connectivity feature of the search query chemical structure;
(c) identifying chemical structures in the database, wherein each chemical structure in the database is associated with a set of molecular keywords such that each molecular keyword of a set of molecular keywords corresponds to a structural connectivity feature of the database chemical structure, and wherein the identified database chemical structures are those database chemical structures whose molecular keywords are a superset of the search query molecular keywords.

33. The computer apparatus as defined in claim 32, wherein the processor identifies chemical structures in the database by comparing the search query molecular keywords to an index that identifies the molecular keywords associated with each of the chemical structures in the database for each of the structural features.

34. The computer apparatus as defined in claim 32, wherein the structural features include one or more from the set of features comprising linear structures, branching points, adjacent branching points, cyclic structures, stereo centers, ring substituent patterns, and atom counts.

35. The computer apparatus as defined in claim 32, wherein the molecular keywords indicate any substructures that are present in the chemical structure.

36. The computer apparatus as defined in claim 32, wherein the processor identifies database chemical structures by performing a partial search query on a portion of the chemical structures database, and generates an estimate of the size of the search query over the entire chemical structures database.

37. The computer apparatus as defined in 32, wherein the processor further performs operations comprising:
identifying a chemical compound within the chemical structures database that is identical to the query chemical structure, identical to a tautomer of the query chemical structure, identical to a superstructure of the query chemical structure, or similar to the query chemical structure.

38. A method for indexing and searching a database containing data representing a plurality of chemical structures, the method comprising:
(a) analyzing the connectivity of each chemical structure representation in the database and generating molecular keywords corresponding to substructures of the chemical structure representations;
(b) producing an index based on the generated molecular keywords;
(c) creating a subset of the generated molecular keywords for each query structure;
(d) searching the database using a search query containing query keywords and utilizing the index;
(e) identifying chemical structure representations that are related to the chemical structure of the search query by
I. being identical to or valid tautomers of the query structure or
II. being a superstructure of the query structure or
III. being similar to the query structure.

39. The method as defined in claim 38, wherein a selected subset of molecular keywords are used based on the frequency of occurrence in a representative database.

40. The method as defined in claim 38, wherein molecular keywords are generated for linear structures, branching points, adjacent branching points, monocyclic, poly-cyclic and macrocyclic ring systems, stereo centers, ring-substituent patterns and molecular-formula atom counts, or any combination thereof.

41. The method as defined in claim 38, further comprising using a tree index for molecular keywords.

42. The method as defined in claim 38, further comprising using a B-tree index for molecular keywords.

43. The method as defined in claim 38, further comprising using a generalized index search tree for molecular keywords.

44. The method as defined in claim 38, wherein the similarity of the hits to the query structure is defined by the number of keywords in common divided by the total number of keywords in both molecules.

45. The method as defined in claim 38, wherein similarity searches are performed by using degenerate keys in the index and the queries.

46. The method as defined in claim 38, further comprising using a keyword search to do a partial query and estimate the size of the result set.

47. A computer assisted method for searching a chemical structure database for a query chemical structure, the method comprising:
a. generating an index of molecular keywords assigned to at least two structural elements of the query chemical structure, said at least two structural elements selected from the group consisting of linear structural elements, branch point structural elements, adjacent branching point structural elements, monocyclic structural elements, poly-cyclic structural elements, macro-cyclic structural elements, stereo-center structural elements, ring-substituent pattern structural elements and molecular formula atom counts; and
b. searching said chemical structure database for said query chemical structure using said index of molecular keywords.

48. The method as defined in claim 47, wherein the index of molecular keywords includes every possible permutation for each atom within each structural element.

49. The method as defined in claim 47, further comprising:
c. identifying a chemical compound within said chemical structure database that is identical to said query chemical structure, a tautomer of said query chemical structure, a superstructure of said query chemical structure, or similar to said query chemical structure.

50. The method as defined in claim 47, wherein searching is performed using a web browser.

51. The method as defined in claim 47, wherein said chemical structure database comprises at least 1 million different chemical compounds.

52. The method as defined in claim 51, further comprising:
c. identifying a chemical compound within said chemical structure database that is identical to said query chemical structure, a tautomer of said query chemical structure, a superstructure of said query chemical structure, or similar to said query chemical structure.

53. The method as defined in claim 52, wherein the operations comprising a, b, and c are performed in less than one second.

54. The method as defined in claim 47, wherein said index of molecular keywords is assigned to at least three, and up to ten structural elements of the query chemical structure.

55. The method as defined in claim 47, wherein said index of molecular keywords comprises of at least 30,000 molecular keywords.

56. A method as defined in claim 47, further comprising generating molecular keywords for partial structures and using them for indexing chemical databases.

57. A computer method for performing a database search, the method comprising:
accessing a high performance text index that analyzes keyword occurrence and keyword performance statistics; and
prioritizing keywords for selectivity.

58. The method as described in claim 57, further comprising:
a. generating an index of molecular keywords assigned to at least two structural elements of the query chemical structure, said at least two structural elements selected from the group consisting of linear structural elements, branch point structural elements, adjacent branching point structural elements, monocyclic structural elements, poly-cyclic structural elements, macro-cyclic structural elements, stereo-center structural elements, ring-substituent pattern structural elements and molecular formula atom counts; and
b. searching said chemical structure database for said query chemical structure using said index of molecular keywords.

59. The method as defined in claim 57, further comprising:
performing a partial search of a database to retrieve the number of result records required to fill a browser page, and storing the state of this search such that a subsequent search retrieves the next browser page.

60. The method as defined in claim 58, wherein the state information is stored as a browser cookie or a link query parameter.
